(19) United States
(12) Patent Application Publication
(10) Pub. No.: US 2018/0018413 A1
(43) Pub. Date: Jan. 18, 2018

(54) METHOD FOR FAST TRANSIENT THERMAL ANALYSIS TO SIMULATE A VEHICLE DRIVE CYCLE

(71) Applicant: GM GLOBAL TECHNOLOGY OPERATIONS LLC, Detroit, MI (US)

(72) Inventors: Shailendra Kaushik, Novi, MI (US); Lee E. Krispin, Rochester Hills, MI (US)

(73) Assignee: GM GLOBAL TECHNOLOGY OPERATIONS LLC, Detroit, MI (US)

(21) Appl. No.: 15/647,931

(22) Filed: Jul. 12, 2017

Related U.S. Application Data
(60) Provisional application No. 62/361,208, filed on Jul. 12, 2016.

(51) Int. Cl. G06F 17/50

(52) U.S. Cl. CPC G06F 17/5009

(57) ABSTRACT

A full-vehicle thermal model of a subject vehicle including a plurality of components can be generated. An experimental design includes input variables and output variables for each of the components under steady-state operating conditions. A meta-model is generated for each of the components based upon the input variables and the output variables. A time history including a time-based variation of the input variables is obtained for a plurality of drive cycles. A time history for a heat transfer coefficient and a film temperature for each of the components is determined based upon the meta-models for the components and the time histories for the plurality of input variables. The time histories for the heat transfer coefficient and the film temperature for the components are provide to a lumped-parameter thermal solver as time-varying boundary conditions, and a time-temperature profile for one of the components is determined employing the lumped-parameter thermal solver.

### CROSS-REFERENCE TO RELATED APPLICATIONS

This application claims the benefit of U.S. Provisional Patent Application No. 62/361,208 filed on Jul. 12, 2016, the disclosure of which is hereby incorporated by reference.

### INTRODUCTION

This disclosure relates to vehicles, and methods associated with transient thermal analysis thereof. Heat management in a vehicle, including management of underhood and underbody heat generated by a powerplant such as an internal combustion engine, is influenced by factors related to vehicle design, packaging, engine power output, fuel economy and emission standards. Integration details can influence vehicle performance and service lives of various components.

### SUMMARY

A method for evaluating a thermal environment associated with a subject vehicle is described, and includes generating a full-vehicle thermal model of the subject vehicle including a plurality of components associated therewith. An experimental design employing the full-vehicle thermal model is executed, wherein the experimental design includes a plurality of input variables and a plurality of output variables for each of the components under steady-state operating conditions, and wherein the output variables include a heat transfer coefficient and a film temperature. A meta-model is generated for each of the components based upon the input variables and the output variables that are determined from executing the experimental design. A time history for the subject vehicle is obtained, and includes a time-based variation of the input variables associated with operating the subject vehicle in each of a plurality of drive cycles. A time history for a heat transfer coefficient and a film temperature for each of the components is determined based upon the meta-models for the components and the time histories for the plurality of input variables. The time history for the heat transfer coefficient and the film temperature for each of the components are provided to a lumped-parameter thermal solver as time-varying boundary conditions, and a time-temperature profile for one of the components is determined employing the lumped-parameter thermal solver.

An aspect of the disclosure includes a device that includes a non-transitory computer readable storage medium storing instructions, that when executed by a processor, cause the processor to perform a method for thermally evaluating the system including the heat engine.

Another aspect of the disclosure includes generating the thermal model of the subject vehicle comprises generating a full-vehicle Computational Fluid Dynamics (CFD) and thermal model of the subject vehicle.

Another aspect of the disclosure includes running a series of steady-state simulations to generate a full-vehicle thermal model of the subject vehicle, include a plurality of components associated therewith.

Another aspect of the disclosure includes the input variables being vehicle speed, fan speed, heat rejection of the internal combustion engine, mass flowrate of an exhaust gas feedstream, temperature of the exhaust gas at an inlet to an exhaust manifold, and ambient temperature.

Another aspect of the disclosure includes the output variables being a component-averaged heat transfer coefficient and a film temperature of the component.

Another aspect of the disclosure includes obtaining a time history in the form of a time-based variation for each of the input variables for each of a plurality of drive cycles.

Another aspect of the disclosure includes generating a meta-model in the form of a Kriging-based response surface for each of the components of the vehicle based upon the input variables and the output variables from the experimental design.

Another aspect of the disclosure includes employing the lumped-parameter thermal solver as a time-varying boundary condition to determine the time-temperature profile for one of the components.

Another aspect of the disclosure includes determining a useful service life of one of the components based upon its time-temperature profile and an Arrhenius equation.

Another aspect of the disclosure includes validating a thermal design of one of the components based upon its time-temperature profile.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically illustrates a top-view of an underhood portion of a subject vehicle including a thermal environment thereof, in accordance with the disclosure;

FIG. 2 schematically shows a method for developing a transient thermal analytical model that may be employed in evaluating a subject vehicle, in accordance with the disclosure;

FIG. 3 schematically shows operation of generating a meta-model for one of the components based upon the input variables and the output variables that are determined from executing the experimental design as described with reference to FIG. 2, in accordance with the disclosure;

FIG. 4-1 schematically shows a thermal analysis for one of the components that is determined employing an analytical representation of a physical system at discrete points, wherein the component is an engine mount that is in close proximity to an exhaust manifold of the engine located in the underhood portion of a subject vehicle, in accordance with the disclosure; and

FIG. 4-2 graphically shows a time-temperature profile for the engine mount that is depicted with reference to FIG. 4-1, including a first temperature profile that was determined experimentally during a validation test and a second temperature profile that was determined employing the concepts described herein, in accordance with the disclosure.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure. The term ‘model’ refers to a processor-based or processor-executable code and associated calibration that simulates a physical existence of a device or a physical process.

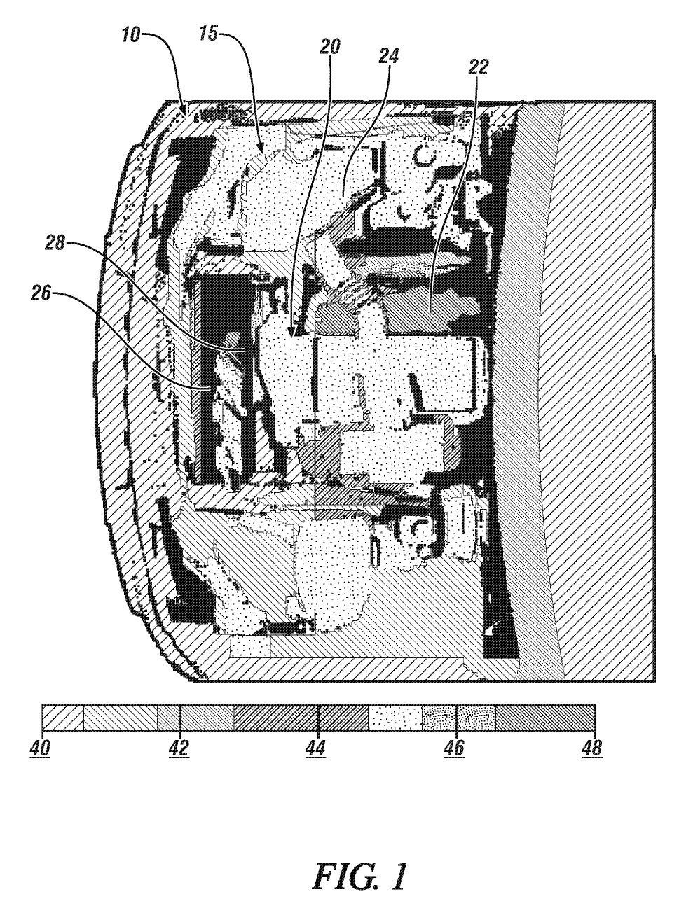

Referring now to the drawings, which are provided for the purpose of illustrating certain exemplary embodiments only and not for the purpose of limiting the same, FIG. 1 schematically illustrates a top-view of an underhood portion 15 of a subject vehicle 10. The subject vehicle 10 may include, by way of non-limiting examples, a passenger vehicle, a light-duty or heavy-duty truck, a utility vehicle, an agricultural vehicle, an industrial/warehouse vehicle, or a recreational off-road vehicle. The subject vehicle 10 may also include an aerospace vehicle. Alternatively, the concepts described herein may apply to thermal management of any configuration that includes a heat engine. The underhood portion 15 of the subject vehicle 10 includes, by way of example, a heat engine in the form of an internal combustion engine 20, an exhaust manifold 22, an air intake system 24, a radiator 26 and a fan 28. A thermal environment of the underhood portion 15 of the subject vehicle 10 is depicted, and includes regions 40, 42, 44, 46 and 48, which indicate temperature boundaries of 40C, 60C, 80C, 100C and 125C, respectively.

Vehicles may be subjected to a myriad of operating and weather conditions over their service lives. Components that are located in a vehicle's underhood/underbody locations (UH/UB) may exceed continuous and excursion temperatures at high ambient temperatures and under load conditions such as trailer towing up an incline. Vehicle development programs may include subjecting a vehicle design to a designed thermal validation test procedure that includes a plurality of driving scenarios at variable high ambient temperatures. The temperatures of thermally sensitive components may be monitored during such test procedures.

Component and system design strategies may include a combination of analysis and synthesis early in a development program and physical testing for validation in the latter part of the development program in order to compress design and development cycles. Math-based analytical tools may be employed as part of thermal management analysis during vehicle, system and component development. A math-based analytical procedure is expected to simulate a given physical process accurately. However, a vehicle's UH/UB thermal environment is complex, and an analytical simulation of a thermal validation test procedure may involve consideration of all three modes of heat transfer—conduction, convection and radiation, in transient operation. Of these three modes, convective heat transfer that primarily depends upon the airflow in the UH/UB of a vehicle necessitates the use of a full vehicle Computational Fluid Dynamics (CFD) model. Computationally the most resource-intensive of the three, a CFD software package may be employed to solve a set of complex, non-linear Navier-Stokes (NS) equations in a discretized form for airflow (convection), in addition to conduction and radiation. A complexity that arises when trying to simulate a thermal sequence test is its transient nature. Not only do different UH/UB components have vastly dissimilar thermal masses, and hence different thermal time constants, they also undergo a continually varying thermal boundary condition as a result of a constantly varying load on the engine. In addition, a CFL (Courant-Friedrich-Levy) criterion that is necessary for numerical stability of explicit NS equations limits the allowable time-step that can be taken during a transient simulation in CFD. The requirement of relatively small time-steps may impede the use of CFD for transient thermal simulations due to limitations in computational resources.

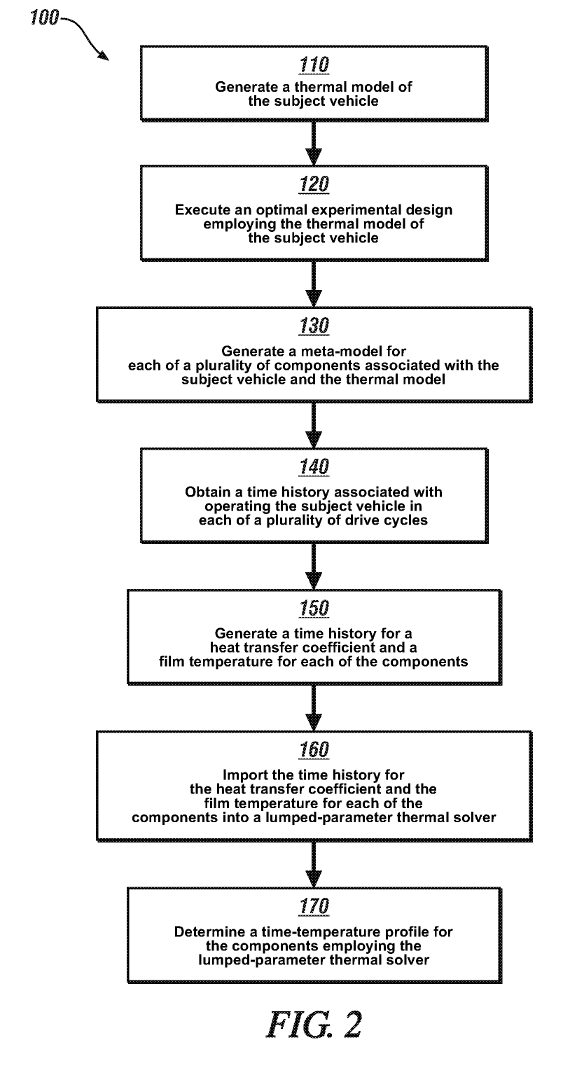

FIG. 2 schematically shows a method for developing a transient thermal analytical model that may be employed in evaluating a subject vehicle, e.g., an embodiment of the subject vehicle 10 described with reference to FIG. 1. Table 1 is provided as a key wherein the numerically labeled blocks and the corresponding functions are set forth as follows. Those having ordinary skill in the art will recognize that the teachings may be described herein in terms of functional and/or logical block components and/or various processing steps. It should be realized that such block components may be composed of any number of hardware, software, and/or firmware components configured to perform the specified functions.

TABLE 1

| BLOCK | BLOCK CONTENTS |
|---|---|
| 110 | Generate a thermal model of the subject |
| | vehicle |
| 120 | Execute an optimal experimental design |
| | employing the thermal model of the subject |
| | vehicle |
| 130 | Generate a meta-model for each of a |
| | plurality of components associated with the |
| | subject vehicle and the thermal model |
| 140 | Obtain a time history associated with |
| | operating the subject vehicle in each of a |
| | plurality of drive cycles |
| 150 | Generate a time history for a heat transfer |
| | coefficient and a film temperature for each |
| | of the components |
| 160 | Import the time history for the heat transfer |
| | coefficient and the film temperature for |
| | each of the components into a lumped- |
| | parameter thermal solver |
| 170 | Determine a time-temperature profile for |
| | the components employing the lumped- |
| | parameter thermal solver |

Overall, a transient thermal analytical model can be developed that may be employed in evaluating a subject vehicle, such as for use in a thermal validation test procedure to obtain time-over-temperature profiles of all components in a vehicle undergoing a thermal sequence test that includes rural highway, city-traffic, idle, soak, highway, trailer-towing on a hill and high-speed vehicle operations. The time-over-temperature profiles may be employed to indicate whether specific components meet continuous and excursion thermal requirements and to predict projected life of the components.

The method includes initially generating a full-vehicle steady-state thermal model of the subject vehicle, including a plurality of components associated therewith (110). A full-vehicle Computational Fluid Dynamics (CFD)/thermal model of the subject vehicle may be generated employing a general-purpose commercially available CFD package that executes a series of simulations of the subject vehicle operating under various steady-state operating conditions. Such steady state operating conditions may include, by way of non-limiting examples, rural highway operation, city-traffic, idle, soak, highway, trailer-towing on a hill and high-speed vehicle operations. A full-vehicle CFD/thermal model may include a computational mesh that includes approximately fifty million tetrahedral cells in one embodiment. Material and surface properties such as thermal conductivity, specific heat capacity, density and emissivity, may be stipulated for all the components that are included in the model. In addition, boundary conditions such as time-averaged values of engine heat rejection, condenser heat rejection, exhaust gas mass flow rate and temperature at the exhaust manifold inlets caused by engine heat rejection via exhaust system, vehicle speed, ambient temperature, engine-cooling fan speed for any vehicle operating condition may be stipulated in order to run a steady-state thermal simulation including time-averaged boundary conditions. The boundary conditions may be obtained from a simulation routine that determines a vehicle's Heating Ventilation and Air Conditioning/Powertrain Cooling (HVAC/PTC) performance, which plays a critical role in relating every system's performance characteristic to a vehicle's HVAC/PTC performance. The simulation routine provides the boundary conditions in terms of radiator heat rejection, engine cooling fan speed, exhaust gas temperature and mass flow rates etc., that are needed for steady-state thermal simulation in the CFD/thermal model for the each of the operating conditions. Since the simulation routine also has a vehicle performance model, in addition to the HVAC/PTC models, it can provide the impact on the HVAC/PTC performance due to a change in the vehicle. For instance, it can determine the effect of changing various parameters such as engine spark timing, vehicle tire size, final driveline axle ratio, fin density of the condenser/radiator, engine cooling fan diameter etc., on the radiator heat rejection, enthalpy into the exhaust system and fan-speed among many others. These represent boundary conditions that may be required in the CFD/thermal model for thermal simulation.

On-vehicle heat exchangers, such as condensers, radiators, oil coolers, etc., are modeled as porous zones in the CFD/thermal model. Their porosity is specified as coefficients of a second-order polynomial fit of pressure drop versus flow-velocity data obtained from an AMCA (Air Movement & Control Association) test-bench. The thermal performance data, e.g., heat rejection capacity of each of the heat exchangers may be prescribed in a tabular form describing heat rejection in terms of air and coolant flow rates. An engine cooling fan may be represented in MRF (moving reference frame) or using a pressure-jump model that requires fan performance curves in terms of pressure versus flow rate. In the latter case, the swirl and the radial velocity components are required to be specified.

The CFD/thermal model numerically solves the governing differential equations of the flow physics on the computational mesh. Fluid flow is governed by a set of non-linear Navier-Stokes equations. Thermal radiation is handled using Discrete Ordinate (DO) partial differential equations. With the aid of conjugate heat transfer that includes a simultaneous solution of convection and conduction in solids and the DO, a steady-state temperature map of the entire vehicle may be obtained. The iterative solution procedure, employed by the CFD/thermal model, is considered converged when the temperatures of all UH/UB components reach steady-state values for a given load condition. It may not account for different thermal masses of different components or changing load conditions that occur during a sequence test. The temperature of components with high thermal masses, such as engine mounts, battery fluid etc., predicted with a steady-state simulation of a trailer-towing hill-climb section, is therefore likely to be over-predicted. The reason for this is the relatively short time period of the trailer-towing section and at the end of which the temperature of these components appear to continue to rise, i.e., they have not reached steady-state. The prediction of maximum temperatures, therefore, may or may not correlate well with the actual test data depending on the component and the load condition under consideration. However, qualitatively it still has considerable value in accurately pointing out the potential hot-spots and their spatial coordinates for thermocouple locations in testing.

Executing an experimental design employing the thermal model of the subject vehicle (120) preferably includes executing an optimal experimental design, such as a Design of Experiments (DoE) employing the CFD/thermal model that is developed in Step 110. Experimental design is the process of planning a study to meet specific objectives with a plurality of input variables and a plurality of output variables, and is known to one of ordinary skill in the art. In one embodiment, an experimental design can be developed to evaluate heat transfer in an UH/UB location of a subject vehicle. The DoE may be an optimal Latin Hypercube DoE in one embodiment. The CFD/thermal model preferably includes a plurality of input variables and a plurality of output variables for each of the components of the subject vehicle under steady-state operating conditions. The input variables may include vehicle speed, fan speed, heat rejection of the internal combustion engine, mass flowrate of an exhaust gas feedstream, temperature of the exhaust gas at an inlet to an exhaust manifold, and ambient temperature in one embodiment. The output variables may include convective heat transfer terms including a heat transfer coefficient and a film temperature for one or more of the UH components in one embodiment.

A meta-model is generated for each of the components based upon the input variables and the output variables that are determined from executing the experimental design (130). A meta-model is an approximation of a physics-based simulation model that models the input/output behavior of a system and is able to provide outputs with reasonable accuracy for various combinations of inputs, employing polynomial regression techniques, Kriging methods and/or neural networks. Kriging is a stochastic based interpolative technique for evaluating input data and output data. In one embodiment, Kriging is a method of interpolation in which interpolated values are modeled by a Gaussian process that is governed by prior covariances of the data. Kriging methods are known to those skilled in the art. In contrast, artificial neural networks and polynomial regression methods use regression-based least-square fits between the inputs and the outputs of a system. As such, meta-modeling techniques may be employed to provide functional evaluations during the process of optimization. A meta-model generates a functional relationship, i.e., a transfer function, between the inputs and the outputs of a model, and is used in to run transient simulations. The inputs in this case are the same key inputs used in CFD/thermal model simulations, i.e., ambient temperature, vehicle speed, fan speed, radiator exit air temperature, exhaust gas mass flow rate and temperature. The outputs include an area-averaged heat transfer coefficient and a film temperature.

In order to create an accurate meta-model between the inputs and outputs, the experimental design employing the CFD/thermal model of the subject vehicle may employ a space-filling technique such as an Optimal Latin Hypercube (OLH). Each run, or steady-state thermal simulation with the CFD/thermal model samples a point in the multi-dimensional input variable space. If enough points are sampled in this space, a sufficiently accurate meta-model that relates the inputs to the heat transfer coefficient and the film temperature can be created using one of the above techniques. Variable order (first to third order) polynomial regressions may be used to relate the inputs and the outputs. The range of each input variable used in the experimental design is determined with the help of the simulation routine of the thermal validation test procedure. Appropriate ranges for all the high-level vehicle parameters are picked from the minimum and the maximum values encountered during the test procedure.

In one embodiment, multiple experimental designs can be executed with the CFD/thermal model based on OLH. The entire process of setting up the runs with a unique combination of input variables in CFD/thermal model and extraction of heat transfer coefficients and film temperature from the resulting data files for all the components is fully automated. In addition, a software program with a graphical user interface may be used to generate the meta-model for determining the heat transfer coefficient and the film temperature for any component. With this ability, and the time-varying input variable data from the simulation routine for any arbitrary thermal test procedure, the software can generate time-dependent heat transfer coefficient and film temperature curve files for running transient simulations. As such, the meta-model may be employed to generate a response surface for each of the components of the vehicle based upon the input variables and the output variables from the experimental design. The response surface developed by the meta-model is a Kriging-based response surface that is employed in evaluating input data and output data.

A time history is obtained for the subject vehicle, and preferably includes a time-based variation of the input variables associated with operating the subject vehicle in each of a plurality of the drive cycles (140). This may include employing the unified vehicle model and the simulation routine for each of a plurality of drive cycles.

Time histories for the heat transfer coefficient and the film temperature for each of the components are generated based upon the meta-models for the components and the time histories for the plurality of input variables (150), preferably employing the response surface generated by the meta-model and the time histories for the plurality of input variables that are developed in Step 130.

The time history for the heat transfer coefficient and the film temperature for each of the components are imported into a lumped-parameter thermal model (160). Lumped-parameter thermal models provide a thermal analysis employing an analytical representation of a physical system at discrete points, i.e., the tetrahedral cells of the computational mesh. A time-temperature profile for one of the components may be determined employing the lumped-parameter thermal solver (170).

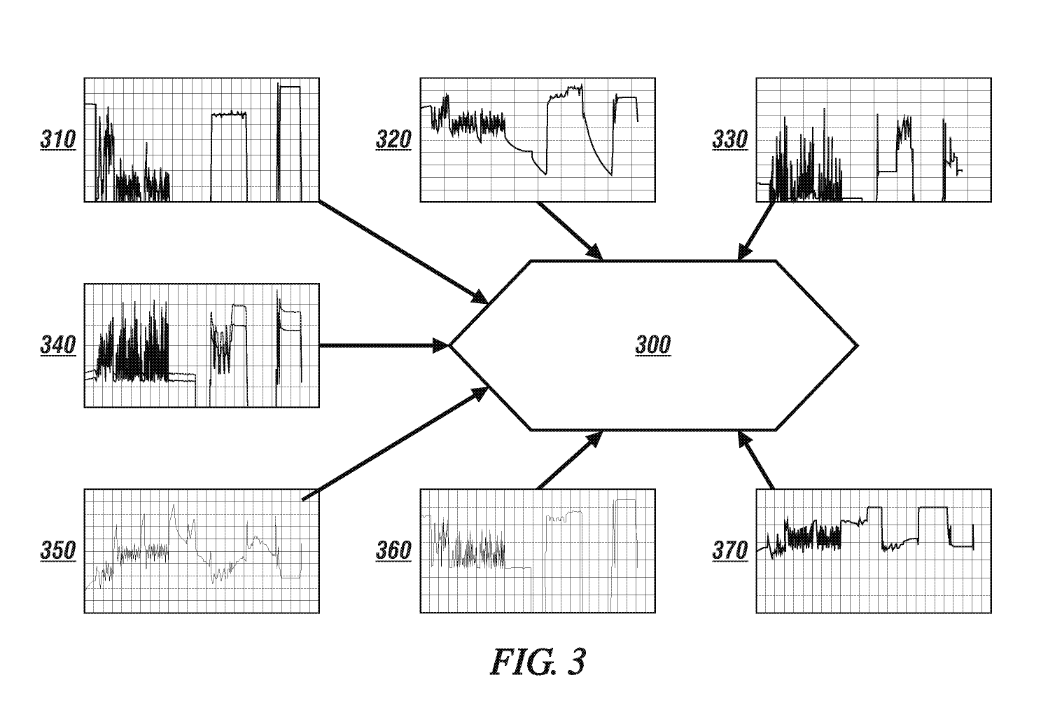

FIG. 3 schematically shows operation of generating a meta-model for one of the components based upon the input variables and the output variables that are determined from executing the experimental design as described with reference to step 130. The input variables include, by way of example, vehicle speed 310, exhaust gas temperature 320, exhaust gas mass flowrate 330, fan speed 340 and radiator exit air temperature 350 which are plotted on the vertical axes in relation to time. The output variables are shown graphically, and include the heat transfer coefficient 360 and the film temperature 370, which are plotted on the vertical axes in relation to time, which is on the horizontal axes. The meta-model process 300, which is described with reference to step 130 of FIG. 2, determines the heat transfer coefficient 360 and the film temperature 370 for all the components at all of the sampled vehicle operating conditions, and generates a meta-model for each of a plurality of components associated with the subject vehicle and the thermal model.

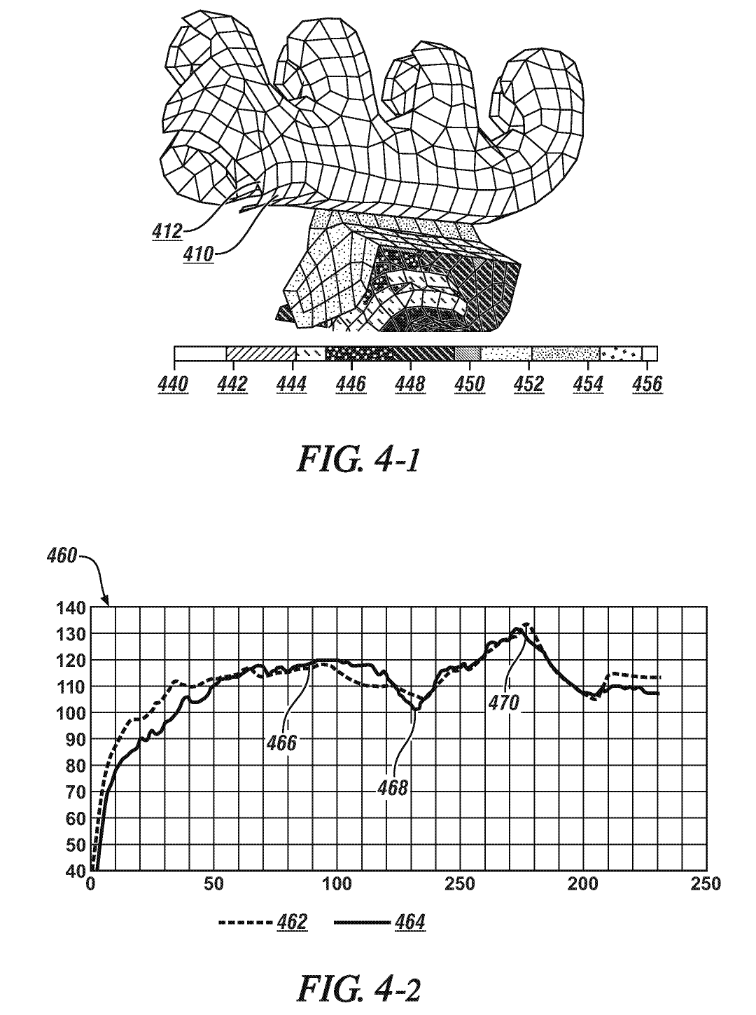

FIG. 4-1 schematically shows, by way of a non-limiting example, a thermal analysis for one of the components that is determined employing an analytical representation of a physical system at discrete points, i.e., the tetrahedral cells of the computational mesh of the component. The depicted component is an engine mount 410 that is proximal to an exhaust manifold 412 of the engine that is located in the underhood portion of a subject vehicle, e.g., the subject vehicle 10 including the internal combustion engine 20 described with reference to FIG. 1. Temperatures are also depicted, and include regions 440, 442, 444, 446, 448, 450, 452, 454 and 456 which indicate temperature boundaries of 40C, 60C, 80C, 100C, 120C, 140C, 160C, 180C and 200C, respectively.

FIG. 4-2 graphically shows a time-temperature profile 460 for the engine mount 410 that is depicted with reference to FIG. 4-1, wherein the time-temperature profile 460 includes a first temperature profile 464 of the engine mount 410 that was determined experimentally during a validation test, and a second temperature profile 462 that was determined employing the lumped-parameter thermal solver. The plotted results indicate that the second temperature profile 462 tracks the first temperature profile 464, including indicating local maximum temperatures 466, local minimum temperatures 468, and overall maximum temperatures 470.

As such, the concepts described herein provide an ability to simulate full vehicle thermal validation test procedure in a reasonable time that is in the order of magnitude of hours instead of weeks or months. This facilitates accurately determining compliance of one or more components of the system to its thermal requirements, and permits timely design modifications. Such information may also be employed to project, predict or otherwise estimate a useful service life of a component using its time-over-temperature profile and Arrhenius equations. This also facilitates use of thermal management strategies and optimization early in the vehicle development process. Furthermore, the concepts described herein may be implemented in a workstation in an environment that includes multiple workstations, wherein the analytical results may be communicated to other local or remote workstations.

The present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium. The terms controller, control module, module, control, control unit, processor and similar terms refer to any one or various combinations of Application Specific Integrated Circuit(s) (ASIC), electronic circuit(s), central processing unit(s), e.g., microprocessor(s) and associated non-transitory memory component in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean any controller-executable instruction sets including calibrations and look-up tables.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

Embodiments may also be implemented in cloud computing environments. In this description, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A method for thermally evaluating a subject vehicle including an internal combustion engine, the method comprising:
generating a thermal model for the subject vehicle, including a plurality of components associated therewith including the internal combustion engine;
executing an experimental design employing the thermal model, wherein the experimental design includes a plurality of input variables and a plurality of output variables for each of the components under steady-state operating conditions, and wherein the output variables include a heat transfer coefficient and a film temperature;
generating a meta-model for each of the components based upon the input variables and the output variables that are determined from executing the experimental design;
obtaining, for the subject vehicle, a time history including a time-based variation of the input variables associated with operating the subject vehicle in each of a plurality of drive cycles;
generating a time history for a heat transfer coefficient and a film temperature for each of the components based upon the meta-models for the components and the time histories for the plurality of input variables;
importing the time history for the heat transfer coefficient and the film temperature for each of the components into a lumped-parameter thermal solver; and
determining a time-temperature profile for one of the components employing the lumped-parameter thermal solver.

2. The method of claim 1, wherein generating the thermal model of the subject vehicle comprises generating a full-vehicle Computational Fluid Dynamics (CFD) and thermal model of the subject vehicle.

3. The method of claim 1 wherein generating a full-vehicle thermal model of the subject vehicle, include a plurality of components associated therewith comprises running a series of steady-state simulations.

4. The method of claim 1, wherein the input variables include vehicle speed, fan speed, heat rejection of the internal combustion engine, mass flowrate of an exhaust gas feedstream, temperature of the exhaust gas at an inlet to an exhaust manifold, and ambient temperature.

5. The method of claim 1, wherein the output variables include a component-averaged heat transfer coefficient and a film temperature of the component.

6. The method of claim 1, comprising obtaining a time history in the form of a time-based variation for each of the input variables for each of a plurality of drive cycles.

7. The method of claim 1, wherein generating a meta-model comprises generating a Kriging-based response surface for each of the components of the vehicle based upon the input variables and the output variables from the experimental design.

8. The method of claim 1, further comprising employing the lumped-parameter thermal solver as a time-varying boundary condition to determine the time-temperature profile for one of the components.

9. The method of claim 1, further comprising determining a useful service life of one of the components based upon its time-temperature profile and an Arrhenius equation.

10. The method of claim 1, further comprising validating a thermal design of one of the components based upon its time-temperature profile.

11. A method for thermally evaluating a system including a heat engine, the method comprising:
generating a thermal model of the system, including a plurality of components associated therewith including the heat engine;
executing an experimental design employing the thermal model, wherein the experimental design includes a plurality of input variables and a plurality of output variables for each of the components under steady-state operating conditions, and wherein the output variables include a heat transfer coefficient and a film temperature;
generating a meta-model for each of the components based upon the input variables and the output variables that are determined from executing the experimental design;
obtaining, for the system, a time history including a time-based variation of the input variables associated with operating the system in each of a plurality of operating cycles;
generating a time history for a heat transfer coefficient and a film temperature for each of the components based upon the meta-models for the components and the time histories for the plurality of input variables;
importing the time history for the heat transfer coefficient and the film temperature for each of the components into a lumped-parameter thermal solver; and
determining a time-temperature profile for one of the components employing the lumped-parameter thermal solver.

12. A device including a non-transitory computer readable storage medium storing instructions, that when executed by a processor, cause the processor to perform a method for thermally evaluating a system including a heat engine, the instruction set executable to:
generate a thermal model of the system, including a plurality of components associated therewith including the heat engine;
execute an experimental design employing the thermal model, wherein the experimental design includes a plurality of input variables and a plurality of output variables for each of the components under steady-state operating conditions, and wherein the output variables include a heat transfer coefficient and a film temperature;
generate a meta-model for each of the components based upon the input variables and the output variables that are determined from executing the experimental design;
obtain, for the system, a time history including a time-based variation of the input variables associated with operating the system in each of a plurality of operating cycles;
generate a time history for a heat transfer coefficient and a film temperature for each of the components based upon the meta-models for the components and the time histories for the plurality of input variables;
import the time history for the heat transfer coefficient and the film temperature for each of the components into a lumped-parameter thermal solver; and
determine a time-temperature profile for one of the components employing the lumped-parameter thermal solver.

13. The device of claim 12, wherein the non-transitory computer readable storage medium and the processor are disposed in a workstation, and wherein the workstation is disposed to communicate with a second workstation.

14. The device of claim 12, wherein the thermal model of the subject vehicle comprises a full-vehicle Computational Fluid Dynamics (CFD) and thermal model of a plurality of components associated with the subject vehicle.

15. The device of claim 12, wherein the input variables include vehicle speed, fan speed, heat rejection of the internal combustion engine, mass flowrate of an exhaust gas feedstream, temperature of the exhaust gas at an inlet to an exhaust manifold, and ambient temperature, and wherein the output variables include a component-averaged heat transfer coefficient and a film temperature of the component.

16. The device of claim 12, wherein the meta-model comprises a Kriging-based response surface for each of the components of the vehicle based upon the input variables and the output variables from the experimental design.

17. The device of claim 12, wherein the lumped-parameter thermal solver is employed as a time-varying boundary condition to determine the time-temperature profile for one of the components.

18. The device of claim 12, further comprising the instruction set executable to determine a useful service life of one of the components based upon its time-temperature profile and an Arrhenius equation.
